(19) United States
(12) Patent Application Publication
(10) Pub. No.: US 2008/0077608 A1
(43) Pub. Date: Mar. 27, 2008

(54) System and method for appraising risk

(75) Inventors: Matthew S. Kaag, Peoria, IL (US); Christine A. Ulrich, Marquette Heights, IL (US); John D. Sigler, Canton, IL (US); Darrel W. Haynes, Morton, IL (US); Douglas C. Meyer, Morton, IL (US); Alida R. Calhoun, Pekin, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/513,114

(22) Filed: Aug. 31, 2006

(51) Int. Cl. G06F 7/00

(52) U.S. Cl. 707/102

(57) ABSTRACT

A system for appraising risk in a facility may include a computer assembly. The system may also include an appraisal tool program having a summary section and facility process sections. The appraisal tool program may be configured to receive input values in the facility process sections. The input values may be indicative of risks associated with facility process practices. The appraisal tool program may also be configured to calculate an overall risk for the facility process sections based on the input values, and display the overall risk in the summary section.

### TECHNICAL FIELD

The present disclosure relates generally to facility management, and more particularly to a system and method for appraising the risks associated with facility processes.

### BACKGROUND

Facilities, such as, for example, warehouses, may be used by manufacturers, importers, exporters, and wholesalers, for storing items. The items maintained in a warehouse may be identified as the warehouse's inventory. At the warehouse a multitude of transactions may be performed during day-to-day operations, including, for example, picking, storing, and delivering items from one location to the next. Warehouse personnel may create records detailing the transactions to track the warehouse's performance, and to track movement of inventory through the warehouse. Records management may include the process of attempting to maintain or enhance the accuracy of those records. By maintaining accurate records, warehouse personnel may help to improve the efficiency of the warehouse, while also minimizing risks that could lead to accidents including, for example, losing inventory, misidentifying items, and committing human errors.

A facility's risk may be reduced by implementing certain practices. If these practices are not followed, or are inadequately performed, then the facility's risk may increase, possibly resulting in any number of adverse consequences. For example, if the facility operates in a high-risk manner, inaccuracies could appear in the facility's records, resulting in increases in customer complaints and shipment delays, and decreases in revenue and overall efficiency. Therefore, managing risk may be critical to ensuring the facility's success.

At least one system has been developed for managing risk. For example, U.S. Patent Publication 2005/0060213 to Lavu et al. (“Lavu”) discloses a risk management tool and method for creating an initial risk management process that captures, assesses, and prioritizes risks and implements mitigation plans to manage risk in large-scale development projects. The risk management tool allows users to search, view and edit risk information stored on a database. However, the risk management tool in Lavu does not identify and determine the level of risk associated with the processes performed in a particular facility, such as, for example, a warehouse. Also, the risk management tool in Lavu does not provide a standard format for conducting audits of two or more facilities, making the task of comparing two or more facilities difficult.

The disclosed system and method is directed to overcoming one or more of the problems set forth above.

### SUMMARY OF THE INVENTION

In one aspect, the presently disclosed embodiments may be directed to a system for appraising risk in a facility. The system may include a computer assembly. The system may also include an appraisal tool program having a summary section and facility process sections. The appraisal tool program may be configured to receive input values in the facility process sections. The input values may be indicative of risks associated with facility process practices. The appraisal tool program may also be configured to calculate an overall risk for the facility process sections based on the input values, and display the overall risk in the summary section.

In another aspect, the presently disclosed embodiments may be directed to a method for appraising risk in a facility using an appraisal tool. The method may include analyzing facility processes by gathering data on facility process practices. The method may also include assigning input values to the facility process practices based on the gathered data. The input values may be indicative of risks associated with the facility process practices. The method may further include entering the input values into facility process sections associated with the facility process practices. The method may further include calculating an overall risk for the facility process sections based on the input values, and displaying the overall risk in a summary section.

### BRIEF DESCRIPTION OF THE DRAWINGS

FIG. 1 is an illustration of a system for appraising risk in a facility according to an exemplary disclosed embodiment of the present disclosure.

FIG. 2 is an illustration of the system for appraising risk in a facility according to another exemplary disclosed embodiment of the present disclosure.

FIG. 3 is a flow diagram of a method for appraising risk in a facility according to an exemplary disclosed embodiment of the present disclosure.

### DETAILED DESCRIPTION

A facility may include any building or place that may provide a particular service or may be used for a particular industry, such as, for example, a warehouse used for storing items. The items stored in the warehouse may be referred to as inventory. Warehouses may be equipped with loading docks and machinery, including cranes and forklifts, for moving its inventory. Inventory may move through the warehouse to storage locations where it may be stored until needed. Warehouse personnel may monitor the inventory, and may create records documenting warehouse processes and transactions. The accuracy of those records may have an influence on the overall efficiency of the warehouse.

Due to the importance of maintaining accuracy in the records, consultants may be employed to help improve record accuracy and to minimize the facility's exposure to risk of loss or error. Consultants may include outside parties and/or warehouse personnel assigned to analyze the facility and recommend and/or implement strategies for maintaining or enhancing record accuracy and reducing risk in general. In analyzing the facility, the consultant may review facility processes performed at the facility. In a warehouse, for example, facility processes may include inventory validation, inbound logistics, warehouse audits, stock count reconciliation, accounts payable, customer claims, returns, parts quality routines, and any suitable facility process known in the art. The consultant may gather information on the facility processes to appraise the risk that each of the facility processes poses to the warehouse.

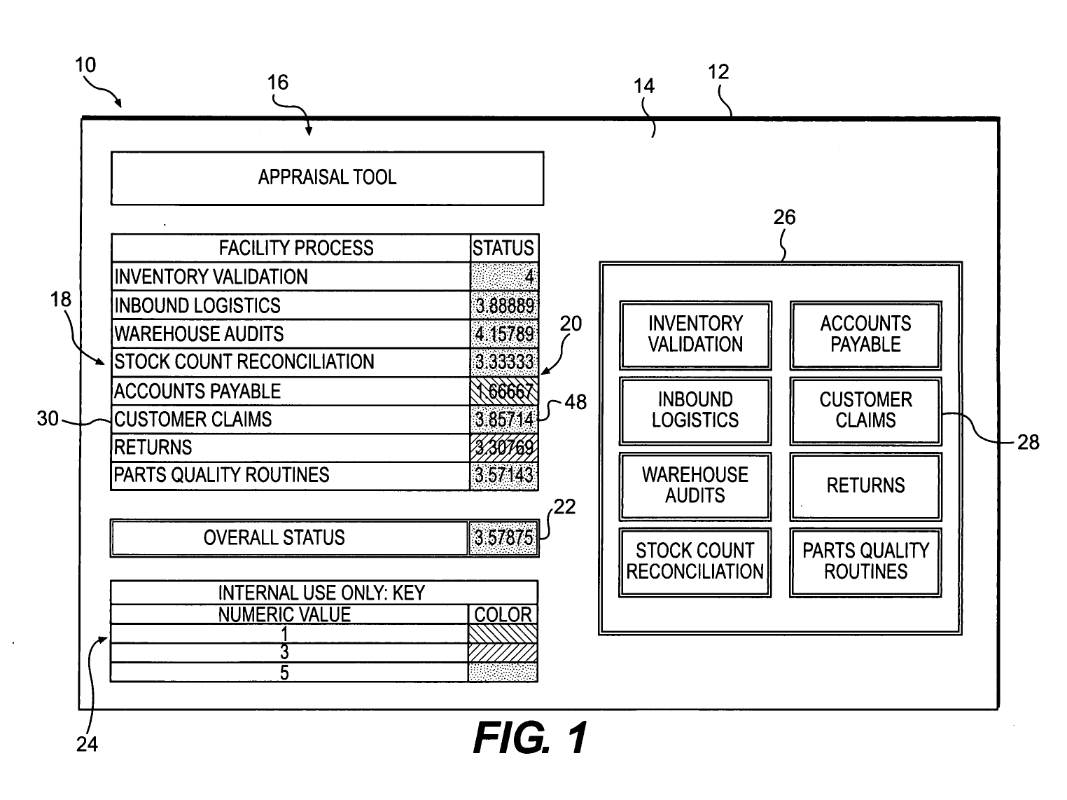

According to one embodiment of the present disclosure, and as shown in FIG. 1, an appraisal tool 10 may be provided for appraising the risk in the facility by visually quantifying risks associated with facility processes. Using appraisal tool 10, the consultant or other user may quickly and intuitively identify high risk facility processes that may be improved or changed. Appraisal tool 10 may include a computer assembly 12 and software, including programs and procedures enabling computer assembly 12 to perform specific tasks. As is well known in the art, software may be loaded into a computer's memory element (not shown), such as, for example, its random access memory, and may be executed in a central processing unit (not shown). Computer assembly 12 may also include a visual display 14, such as, for example, a computer screen or similar device, for displaying text, symbols, and other graphics. Furthermore, computer assembly 12 may include one or more input devices (not shown) for entering information, including a keyboard, mouse, stylus, and one or more output devices (not shown), including a printer, audio speakers, and/or any other suitable input and output devices known in the art. It is also contemplated that appraisal tool 10 may include the software itself, which may be stored on a computer readable medium.

A summary section 16, such as, for example, a chart, table, web page, or spreadsheet, may be generated on visual display 14. In one embodiment, appraisal tool 10 may include Microsoft Excel or any other suitable computer program. Summary section 16 may include one or more facility process fields 18 in which facility processes may be listed. For example, a facility process field 30 may be provided for the facility process of handling customer claims. Summary section 16 may also include one or more summary status fields 20 adjacent to facility process fields 18. Summary section 16 may further include a summary overall status field 22 and key 24. A navigation menu 26 including one or more menu buttons 28 may also be provided. Each menu button may correspond to a particular facility process listed in facility process fields 18.

Summary status fields 20 may receive numerical values and/or other inputs. The numerical values entered into summary status fields 20 may become summary status field values. Appraisal tool 10 may illustrate summary status fields 20 with visual indicators representative of the magnitude of the summary status fields' values. As shown in key 24, appraisal tool 10 may visual indicator any summary status field having a value of “1” with the visual indicator green. Appraisal tool 10 may visual indicator any summary status field having a value of “3” with the visual indicator yellow, and any having a value of “5” with the visual indicator red. The numerical values may remain visible even after the fields are colored by appraisal tool 10, thus allowing the numerical values and the visual indicators to be simultaneously visible. Coloring may also be applied to summary status fields having non-whole number values. It should be understood that the range of values associated with each visual indicator may be selectively adjusted by the consultant or user. The numerical value and visual indicator in each of summary status fields 20 may be indicative of the level or degree of risk associated with its corresponding facility process. Furthermore, this relationship between the numerical values and the coloring used for the fields may be consistent throughout all of the sections of appraisal tool 10. It is also contemplated that the visual indicator may include shading, hatching, text effects (e.g. bolding, underlining, and/or italicizing) or any other suitable visual indicator in place of or in addition to the coloring.

Appraisal tool 10 may calculate an average from the summary status field values. The average may include the mean, median, mode, or any other suitable statistical value. Appraisal tool 10 may automatically input the average into summary overall status field 22, giving it a summary overall status field value. Appraisal tool 10 may assign a visual indicator to summary overall status field 22 based on its value in the same manner described above with respect to summary status fields 20. The numerical value and visual indicator in summary overall status field 22 may indicate the level or degree of risk for the overall facility based on the degrees of risk associated with all of the facility processes.

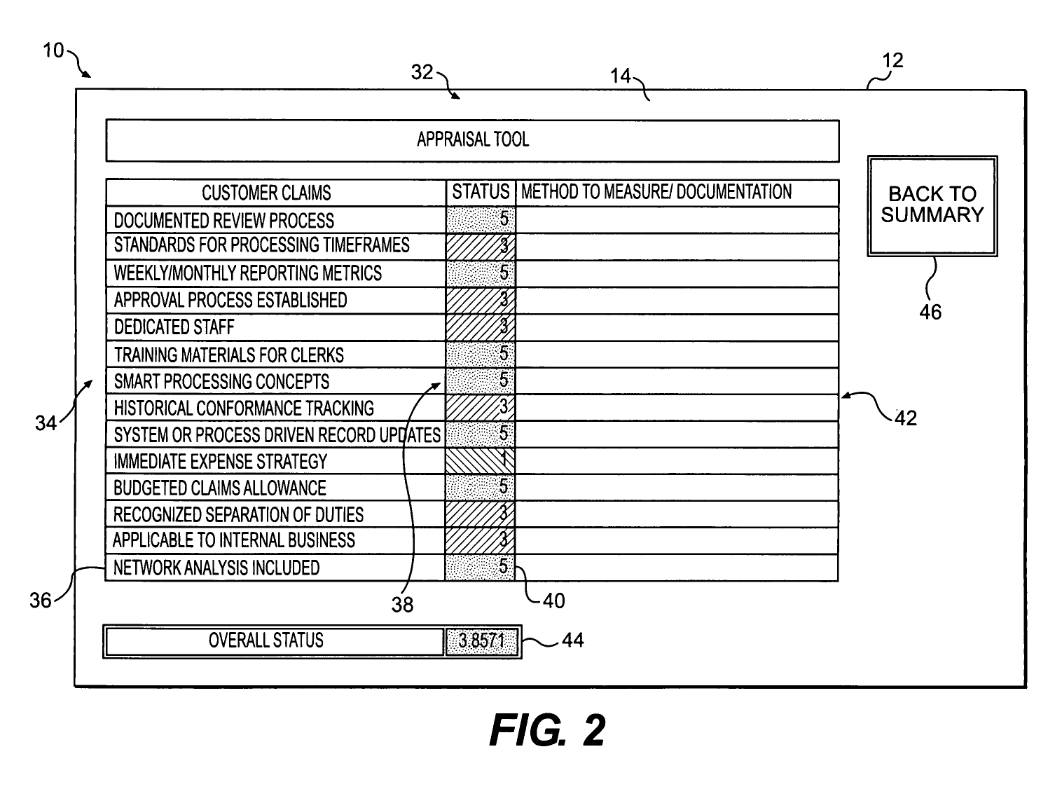

Navigation menu 26 may be provided to allow the consultant or user to navigate between one or more sections of appraisal tool 10. In embodiments where appraisal tool 10 is a web-based application, navigation menu 26 may provide one or more links to web pages containing the sections. In one embodiment, each facility process listed in facility process fields 18 may have its own facility process menu button in navigation menu 26. When the consultant or user clicks or otherwise selects a facility process menu button, the consultant or user may be directed to a specific section for the facility process. For example, if the consultant or user selects facility process menu button 28, appraisal tool 10 may generate a facility process section 32, including, for example, a chart, spreadsheet, web page, or table, on visual display 14, as shown in FIG. 2 of the drawings.

Elements of facility process section 32 will now be discussed in greater detail, and it should be understood that appraisal tool 10 may include other or additional facility process sections for other or additional facility processes. Facility process section 32 may include facility process practice fields 34 for facility process practices. The facility process practices may include tools, methods, strategies, and/or best practices for reducing risk associated with the facility process. For example, a facility process practice field 36 may include a practice for reducing risk in the handling of customer claims, the practice including using network analysis.

Facility process section 32 may also include facility process status fields 38 adjacent to facility process practice fields 34. The consultant or user may enter values into facility process status fields 38. In one embodiment, the consultant or user may input either a “1,” “3,” or “5” into facility process status fields 38. In another embodiment, the consultant or user may enter raw data into facility process status fields 38, the raw data including, for example, performance measures, historical data, and any other suitable information obtained from analyzing the facility, and appraisal tool 10 may automatically calculated an input value based on the raw data. Once inputted into facility process status fields 38, those numerical values may be referred to as facility process status field values. Appraisal tool 10 may fill each of facility process status fields 38 with a visual indicator based upon the magnitude of their respective facility process status field values. As mentioned previously, appraisal tool 10 may fill any facility process status fields having a value of “1” with a visual indicator, such as, for example, the visual indicator green. Appraisal tool 10 may fill any facility process status fields having a value of “3” with the visual indicator yellow, and any facility process status fields having a value of “5” with the visual indicator red.

It is also contemplated that the visual indicator may include shading, hatching, text effects (e.g. bolding, underlining, and/or italicizing), or any other suitable visual indicator in place of or in addition to the coloring. It is further contemplated that appraisal tool 10 may automatically make suggestions or recommendations on the best practices for the facility process based on the value inputted into facility process status fields 38.

The numbers and visual indicators in facility process status fields 38 may be indicative of the degree of risk associated with each of the facility process practices listed. In one embodiment, the degree of risk may be based on the level to which the facility process practices are being utilized in the facility. For example, a facility process status field 40 may have a value of “5” and red coloring. This may suggest that the consultant or user has determined that facility process practice 36 may be non-existent or unused, and thus, there may be a high degree of risk associated with the lack of that facility process practice in the facility. A value of “3” and yellow coloring may suggest that a particular facility process practice is present, but underutilized (e.g., used infrequently or used incorrectly), and thus, may indicate a medium risk associated with that facility process practice. A value of “1” and green coloring may suggest that a particular facility process practice is being fully utilized in the facility, and thus, may indicate a low risk associated with that facility process practice.

Facility process documentation fields 42 may be provided adjacent to facility process status fields 38. The consultant or user may enter notes, comments, and other information into facility process documentation fields 42 to explain why particular values were entered into facility process status fields 38. Additionally or alternatively, facility process documentation fields 42 may include formulas for calculating facility process status field values. Further, facility process documentation fields 42 may automatically display suggestions or recommendations for best practices for the facility process based on the value inputted into facility process status fields 38.

Facility process section 32 may also include a facility process overall status field 44. Appraisal tool 10 may take an average of the facility process status field values, and may automatically input it into facility process overall status field 44, giving facility process overall status field 44 a facility process overall status field value. Appraisal tool 10 may generate a visual indicator in facility process overall status field 44 based on the facility process overall status field value. The type of visual indicator generated for a particular value may be selectively adjusted by the consultant or user. In the example shown here, a facility process overall status field value of 3.8571 may be assigned the visual indicator red. The facility process overall status field value and visual indicator may indicate the level or risk associated with the facility process for which the section was created. For example, a facility process overall status field value evoking green coloring may indicate that there is little or no risk associated with the facility process, while facility process overall status fields evoking yellow or red coloring may indicate increasing levels or degrees of risk for the particular facility process.

Facility process section 32 may also include a return button or link 46. When the consultant or user clicks on or otherwise selects return button or link 46, appraisal tool will direct the consultant or user back to summary section 16. Each facility process section of appraisal tool 10 may include a return button or link similar to return button or link 46.

Facility process overall status field 44 may be directly linked to a summary status field 48 in summary section 16, such that both fields may have the same value and coloring. For example, appraisal tool 10 may automatically transfer the facility process overall status field value and coloring from facility process overall status field 44 to summary status field 48. It should be understood that the values and coloring in the rest of summary status fields 20 may be linked to facility process overall status field values of other facility process sections (not shown). It is contemplated that these other facility process sections may include less, more, or different facility process practices.

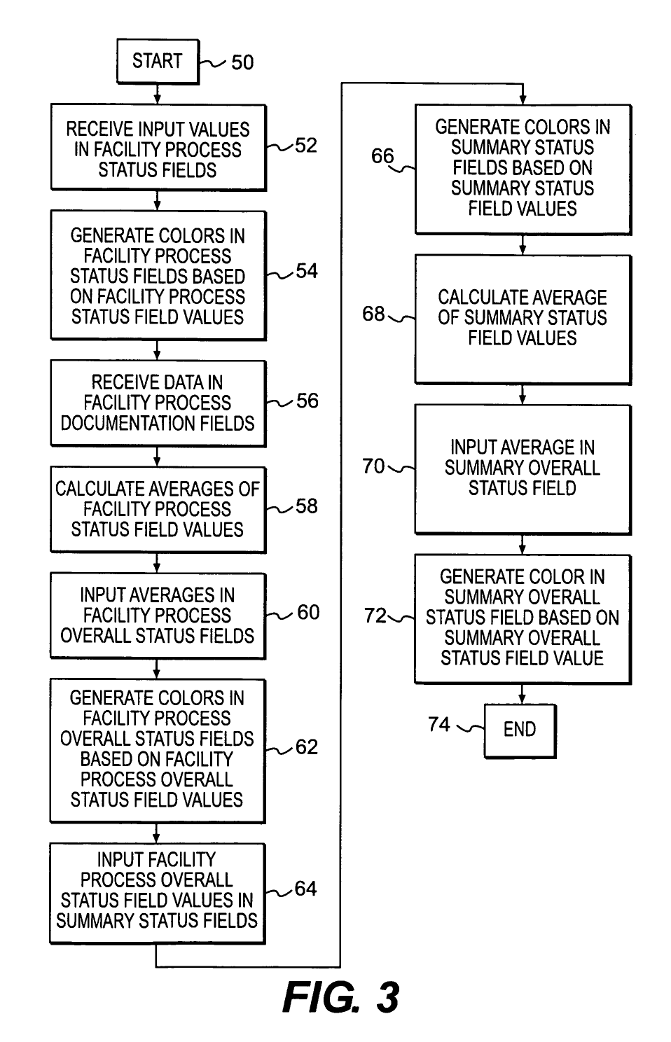

One embodiment of the method of appraising risk performed with appraisal tool 10 will now be described, referring to the flow diagram shown in FIG. 3. Once appraisal tool 10 is started (step 50), it may receive input values in its facility process status fields 38 (step 52). The input values may be entered by the consultant or user after analyzing and observing the facility and the facility processes occurring therein. For example, the consultant or user may identify one or more warehouse employees having experience with a facility process listed in facility process fields 18. The consultant or user may ask the warehouse employee questions about the facility process, including questions concerning facility process practices associated with the facility process. Based on this information, and on information gained from observing the facility, the consultant or user may assign a numerical value to each of the facility process practices, and may enter the values into facility process status fields 38 of facility process section 32. The consultant or user may repeat these steps to fill in each of the other facility process sections (not shown).

Appraisal tool 10 may generate visual indicators in facility process status fields 38 based on the facility process status field values (the values entered into facility process status fields 38) (step 54). Documentation in the form of notes, formulas, and other types of data, may also be provided in facility process documentation fields 42 (step 56) to help explain why certain values were assigned and entered in facility process status fields 38. Then appraisal tool 10 may calculate averages for the facility process status field values (step 58) of each section, and may enter the averages in facility process overall status fields, such as facility process overall status field 44 (step 60). Coloring may be generated in the facility process overall status fields based on the facility process overall status field values (step 62). The facility process overall status field values may be entered in summary status fields 20 of summary section 16 (step 64), after which visual indicators may be generated in summary status fields 20 based on the summary status field values (step 66). Appraisal tool 10 may once again calculate an average, this time from the summary status field values (step 68). The average may be entered into summary overall status field 22 (step 70) and coloring may be generated based on the summary overall status field value (step 72), at which point the method may end (step 74).

Additionally or alternatively, the consultant or user may show visual display 14 and the one or more sections to the facility's owner or operator to visually convey the degree of risk the facility is exposed to based on its facility processes. The information on the sections may also be printed out in a report or other deliverable that may be sent to the facility owner or operator.

### INDUSTRIAL APPLICABILITY

The disclosed system and method for appraising risk may have applicability in assessing risks in facilities.

The system may include an appraisal tool for receiving information, performing calculations, and visually quantifying risk associated with warehouse and inventory management. By visual indicator-coding fields, appraisal tool may provide a consultant, user, facility owner, or facility operator with the ability to quickly identify high risk facility processes that should be improved and changed.

Appraisal tool 10 may be used on-site with new facility start-ups as well as with existing facilities having problems, including, for example, record accuracy issues. Additionally or alternatively, logistics providers may use appraisal tool 10 to identify key areas of risk for their customers. Generally speaking, appraisal tool 10 may be used to assist in most types of audits performed on facilities. Appraisal tool 10 may also provide a standardized auditing tool for use on multiple facilities so that the facilities may be more easily compared to each other.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A system for appraising risk in a facility, comprising:
a computer assembly; and
an appraisal tool program having a summary section and facility process sections, the appraisal tool program being configured to:
receive input values in the facility process sections, wherein the input values are indicative of risks associated with facility process practices; and
calculate an overall risk for the facility process sections based on the input values, and display the overall risk in the summary section.

2. The system of claim 1, wherein the appraisal tool program is further configured to:
calculate averages for the input values; and
automatically input the input value averages into the facility process sections.

3. The system of claim 2, wherein the appraisal tool program is further configured to generate visual indicators in the facility process sections based on the input value averages, the visual indicators being indicative of the degree of risk associated with the facility process practices.

4. The system of claim 2, wherein the appraisal tool program is further configured to automatically input the input value averages into the summary section.

5. The system of claim 4, wherein the appraisal tool program is further configured to generate visual indicators in the summary section based on the input value averages, the visual indicators being indicative of the degree of risk associated with the facility process practices.

6. The system of claim 4, wherein the appraisal tool program is further configured to:
calculate an overall average of the input value averages; and
automatically input the overall average into the summary section.

7. The system of claim 6, wherein the appraisal tool program is further configured to generate a visual indicator in the summary section based on the overall average, the visual indicator being indicative of the degree of risk associated with the facility.

8. The system of claim 1, wherein the appraisal tool program is further configured to display recommendations based on the received input values.

9. The system of claim 1, wherein the appraisal tool program is further configured to:
categorize the risks by generating indicators in the facility process sections; and
categorize the overall risk by generating an indicator in the summary section.

10. The system of claim 1, wherein the appraisal tool program is further configured to receive raw data and automatically calculate the input values from the raw data.

11. A method for appraising risk in a facility using an appraisal tool, the method comprising:
analyzing facility processes by gathering data on facility process practices;
assigning input values to the facility process practices based on the gathered data, wherein the input values are indicative of risks associated with the facility process practices;
entering the input values into facility process sections associated with the facility process practices; and
calculating an overall risk for the facility process sections based on the input values, and displaying the overall risk in a summary section.

12. The method of claim 11, wherein the appraisal tool calculates averages for the input values and automatically inputs the input value averages into the facility process sections.

13. The method of claim 12, wherein the appraisal tool generates visual indicators in the facility process sections based on the input value averages, the visual indicators being indicative of the degree of risk associated with the facility process practices.

14. The method of claim 12, wherein the appraisal tool automatically inputs the input value averages into the summary section.

15. The method of claim 14, wherein the appraisal tool generates visual indicators in the summary section based on the input value averages, the visual indicators being indicative of the degree of risk associated with the facility process practices.

16. The method of claim 14, wherein the appraisal tool calculates an overall average of the input value averages, and automatically inputs the overall average into the summary section.

17. The method of claim 16, wherein the appraisal tool generates a visual indicator in the summary section based on the overall average, the visual indicator being indicative of the degree of risk associated with the facility.

18. The method of claim 11, wherein the steps of analyzing the facility processes, assigning input values, and entering the input values are automatically performed by the appraisal tool program upon receiving raw data from a consultant.

19. The method of claim 11, further including calculating overall risks for a plurality of facilities, and comparing the overall risks to determine which of the plurality of facilities has the greatest risk.

20. The method of claim 11, wherein the appraisal tool automatically displays recommendations based on the received input values.
